(19) United States
(12) Patent Application Publication
(10) Pub. No.: US 2026/0073296 A1
(43) Pub. Date: Mar. 12, 2026

(54) Generating Selectable Links to Implement Generative AI Recommendations

(71) Applicant: Oracle International Corporation, Redwood Shores, CA (US)

(72) Inventors: Yogendra Swami, Hyderabad (IN); Pyay Aung San, San Francisco, CA (US); Cynthia Mariela Munoz Jugo, Cincinnati, OH (US); George M Cherian, Thiruvananthapuram (IN)

(73) Assignee: Oracle International Corporation, Redwood Shores, CA (US)

(21) Appl. No.: 19/184,393

(22) Filed: Apr. 21, 2025

Related U.S. Application Data
(60) Provisional application No. 63/692,161, filed on Sep. 8, 2024.

(51) Int. Cl. G06N 20/00

(52) U.S. Cl. CPC G06N 20/00

(57) ABSTRACT

Techniques for generating actionable links to Artificial Intelligence (AI)-generated content are disclosed. A system generates a prompt to a generative AI model to generate content, including a recommended action based on a set of analyzed data. The prompt further includes instructions to identify a resource used to generate the recommended action. The generative AI model identifies resources used to generate the recommended action based on a set of resources included in the prompt or based on fine-tuning the generative AI model with a dataset that includes system tools available in a system. A system analyzes content output from the generative AI model to identify a recommended action. The system matches the functionality of a resource used to generate the recommendation with the recommended action. The system generates software code to link the AI-generated content to the resource with functionality to perform the recommended action.

### BENEFIT CLAIMS; RELATED APPLICATIONS; INCORPORATION BY REFERENCE

This application claims the benefit of U.S. Provisional Patent Application 63/692,161, filed Sep. 8, 2024, which is hereby incorporated by reference.

The Applicant hereby rescinds any disclaimer of claim scope in the parent application(s) or the prosecution history thereof and advises the USPTO that the claims in this application may be broader than any claim in the parent application(s).

### TECHNICAL FIELD

The present disclosure relates to generating custom links that enable users to take actions recommended by a generative Artificial Intelligence (AI) model.

### BACKGROUND

Enterprises manage various programs to achieve strategic objectives. Programs are implemented by executing a collection of projects that are directed to achieve the strategic objective. Program managers frequently find it challenging to quickly grasp the overall status of their programs and pinpoint the projects within the programs that require immediate attention, especially when dealing with complex financial metrics. This process can be time-consuming and demanding, increasing the risk of errors and the likelihood of missing critical details that affect the success of the program.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The embodiments are illustrated by way of example and not by way of limitation in the figures of the accompanying drawings. It should be noted that references to “an” or “one” embodiment in this disclosure are not necessarily to the same embodiment, and they mean at least one. In the drawings:

FIGS. 1A-1C illustrate a system in accordance with one or more embodiments;

FIGS. 2A and 2B illustrate an example set of operations for generating selectable links in AI-generated recommendations to implement AI-recommended actions in accordance with one or more embodiments;

FIG. 3 illustrates an example set of operations for fine-tuning a generative AI model to specify system resources associated with a recommendation in accordance with one or more embodiments;

FIGS. 4A-4C illustrate an example graphical user interface (GUI) according to an embodiment; and

FIG. 5 shows a block diagram that illustrates a computer system in accordance with one or more embodiments.

### DETAILED DESCRIPTION

In the following description, for the purposes of explanation, numerous specific details are set forth to provide a thorough understanding. One or more embodiments may be practiced without these specific details. Features described in one embodiment may be combined with features described in a different embodiment. In some examples, well-known structures and devices are described with reference to a block diagram form to avoid unnecessarily obscuring the present disclosure.
1. GENERAL OVERVIEW
2. GENERATIVE AI CONTENT GENERATION ARCHITECTURE
3. GENERATING SELECTABLE LINKS IN AI-GENERATED CONTENT TO IMPLEMENT RECOMMENDED ACTIONS
4. FINE-TUNING A GENERATIVE AI MODEL
5. EXAMPLE EMBODIMENT
6. COMPUTER NETWORKS AND CLOUD NETWORKS
7. HARDWARE OVERVIEW
8. MISCELLANEOUS; EXTENSIONS

### 1. General Overview

Generative Artificial Intelligence (AI) models are powerful tools that can analyze a system in accordance with a prompt and provide recommendations for a user to take action. In an example, a user may submit a prompt that requests a generative AI model to determine a solution for the delays in the completion of a particular workflow. The generative AI model, possibly in collaboration with and/or input from other components, may generate a recommendation to allocate additional resources to a particular component that has been identified as a bottleneck for the workflow. Then, a user is required to determine how to initiate the action recommended by the generative AI model.

One or more embodiments supplement recommendations from a generative AI model to enable actions corresponding to the recommendations. The system analyzes a recommendation from a generative AI model in view of functionality for a component associated with the recommendation. Based on the analysis, the system generates and presents links that enable a user to take action in accordance with a generative AI model recommendation. Initially, the system submits a prompt to a generative AI model. The prompt submitted by the system to the generative AI model may be based on a request and/or user prompt received from a user. The system may augment a user prompt by requesting a solution to a problem with a request for the generative AI model to identify components and information that are used by the generative AI model to determine the solution. Augmenting the user prompt results in creating a prompt that the system submits to the generative AI model. The system receives a response from the generative AI model that includes one or more recommended actions (referred to herein as “generative AI model recommendations”) that address the problem identified in the prompt.

Furthermore, the response from the generative AI model identifies information and/or components that were analyzed to determine the recommended actions. The system analyzes the output of the generative AI model, including both the recommended actions and the information and/or components that were analyzed by the generative AI model, to determine the recommended actions. Based on the analysis, the system determines target functionality associated with the components that enable the user to initiate the recommended actions. The system generates custom links for accessing the target functionality associated with the components. The system presents the custom links with the recommended actions from the generative AI model. The custom links may be embedded within the recommended actions or provided separately. As an example, the system may convert text corresponding to the recommended actions to a hyperlink that references a dashboard for accessing the target functionality associated with the component(s). The custom link may itself be configured as a command such that selection of the custom link results in the system performing the action recommended by the generative AI model.

One or more embodiments described in this Specification and/or recited in the claims may not be included in this General Overview section.

### 2. Content Generation Architecture

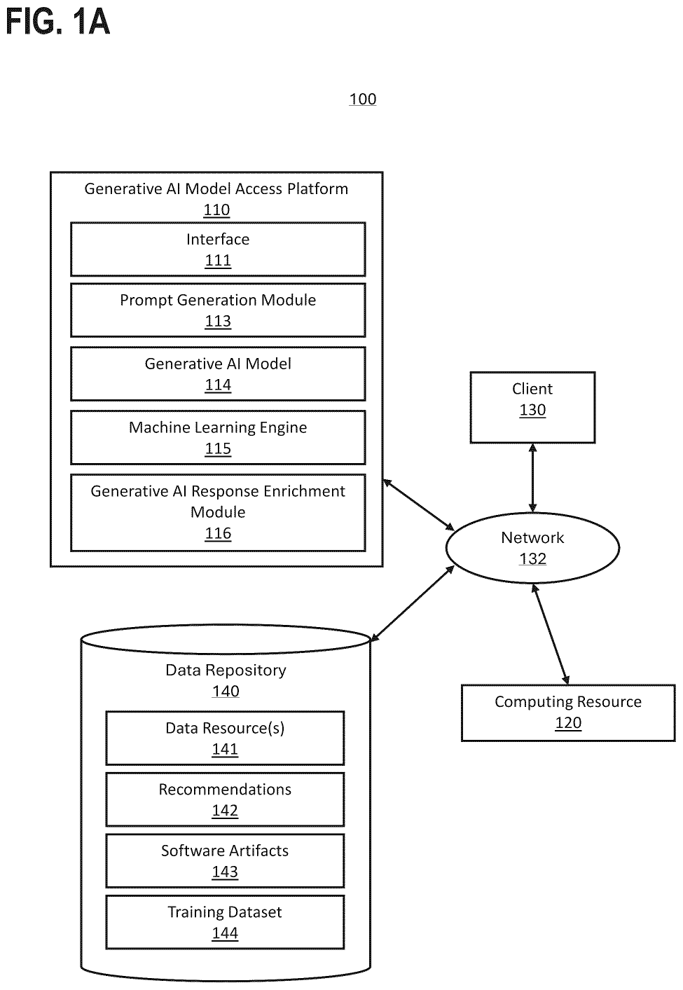

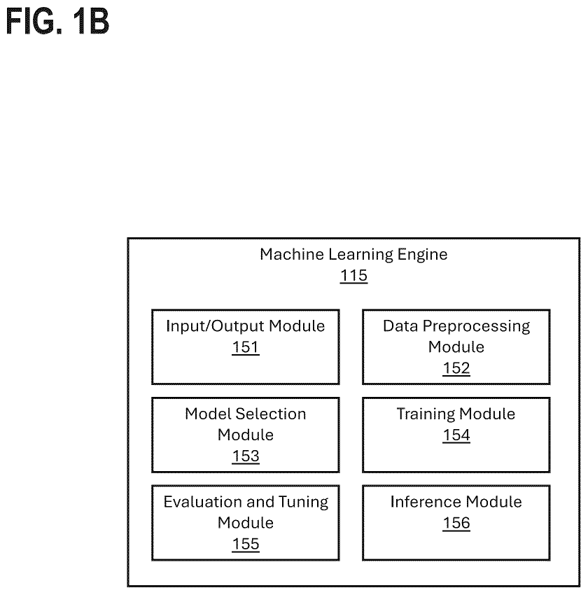

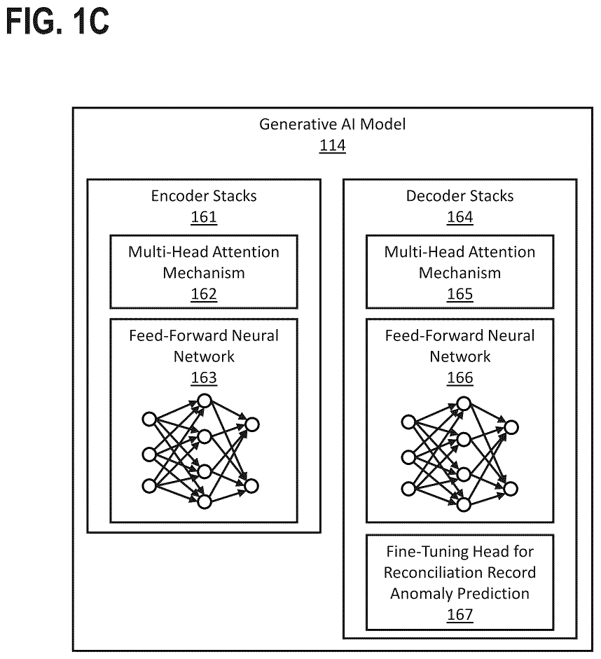

FIG. 1A illustrates a system 100 in accordance with one or more embodiments. As illustrated in FIG. 1A, system 100 includes a generative AI model access platform 110, a computing resource 120, a client 130, and a data repository 140. In one or more embodiments, the system 100 may include more or fewer components than the components illustrated in FIG. 1A. The components illustrated in FIG. 1A may be local to or remote from each other. The components illustrated in FIG. 1A may be implemented in software and/or hardware. Each component may be distributed over multiple applications and/or machines. Multiple components may be combined into one application and/or machine. Operations described with respect to one component may instead be performed by another component.

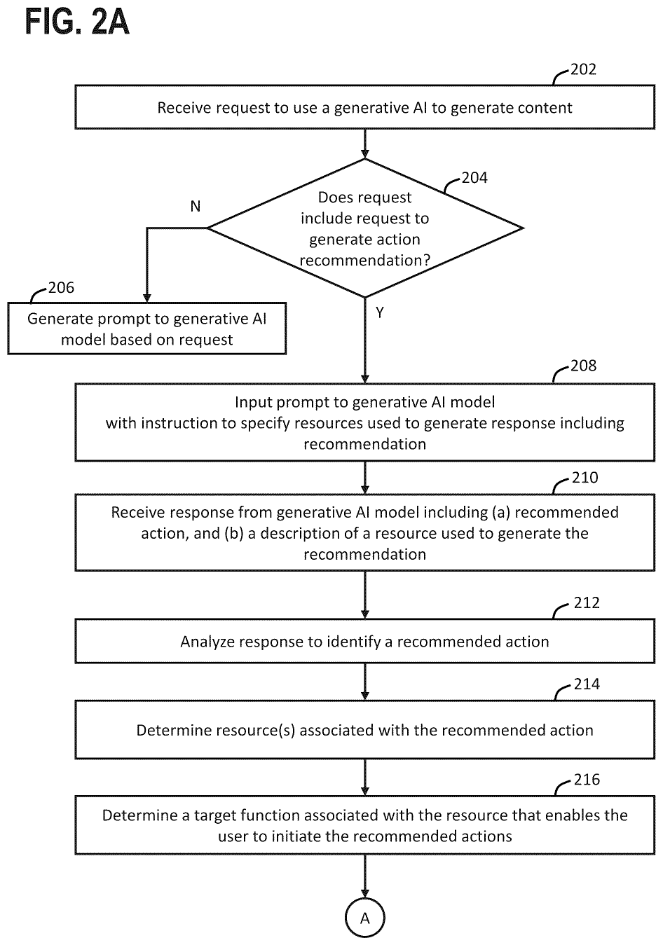

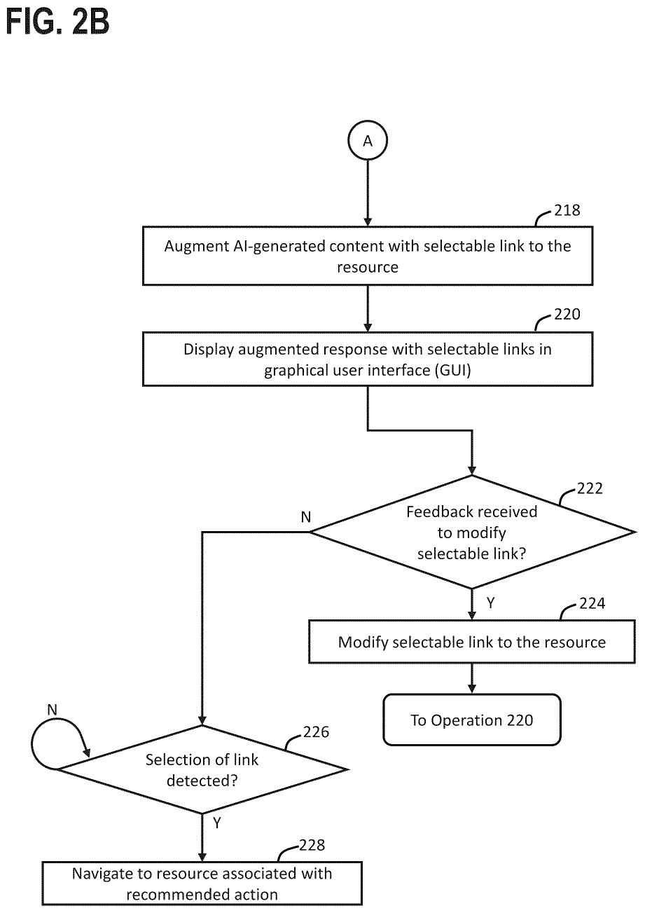

In one or more embodiments, a generative AI model access platform 110 refers to hardware and/or software configured to perform operations described herein for providing clients 130 with access to a generative AI model 114. The generative AI model access platform 110 receives requests, generates prompts, receives responses, and augments the responses generated by the generative AI model 114. Augmenting responses includes generating selectable links in responses to the client 130 based on resources 120 used to generate a response. Examples of operations for generating selectable links in generative AI responses are described below with reference to FIGS. 2A and 2B.

In an embodiment, the generative AI model access platform 110 is implemented on one or more digital devices. The term “digital device” generally refers to any hardware device that includes a processor. A digital device may refer to a physical device executing an application or a virtual machine. Examples of digital devices include a computer, a tablet, a laptop, a desktop, a netbook, a server, a web server, a network policy server, a proxy server, and a mainframe.

In one or more embodiments, a data repository 140 is any type of storage unit and/or device (e.g., a file system, database, collection of tables, or any other storage mechanism) for storing data. Furthermore, a data repository 140 may include multiple different storage units and/or devices. The multiple different storage units and/or devices may or may not be of the same type or located at the same physical site. Furthermore, a data repository 140 may be implemented or executed on the same computing system as the generative AI model access platform 110. Additionally, or alternatively, a data repository 140 may be implemented or executed on a computing system separate from the generative AI model access platform 110. The data repository 140 may be communicatively coupled to the generative AI model access platform 110 via a direct connection or via a network 132.

Information describing data resources 141, recommendations 142, and software artifacts 143 may be implemented across any of the components within the system 100. However, this information is illustrated within the data repository 140 for purposes of clarity and explanation.

A client 130 interacts with an interface 111 to generate a request. The request includes instructions for a generative AI model 114 to generate content that includes at least one recommended action. For example, the interface 111 may generate display data that is displayed to the client 130 as a GUI. The display data may include data representing one or more software artifacts 143, such as a web page or a document. The displayed data may include an interface element that a user may select to generate a request. For example, if the software artifact 143 includes a set of files for displaying a webpage, the interface element may direct the generative AI model access platform 110 to generate of a generative AI prompt. The generative AI prompt directs the generative AI model to generate content to be displayed on the webpage or in a document.

In one or more embodiments, interface 111 refers to hardware and/or software configured to facilitate communications between a user and the generative AI model access platform 110. Interface 111 renders user interface elements and receives input via user interface elements. Examples of interfaces include a graphical user interface (GUI), a command line interface (CLI), a haptic interface, and a voice command interface. Examples of user interface elements include checkboxes, radio buttons, dropdown lists, list boxes, buttons, toggles, text fields, date and time selectors, command lines, sliders, pages, and forms. In an embodiment, the generative AI model access platform 110 transmits display data to client 130 to display a GUI on a display device associated with the client 130. A user interacts with interface elements in the GUI to generate requests for a generative AI model 114 to generate content in software artifacts 143, such as documents, forms, and webpages. The client device 130 displays the documents, forms, and webpages on the display device of the client 130.

In an embodiment, different components of interface 111 are specified in different languages. The behavior of user interface elements is specified in a dynamic programming language such as JavaScript. The content of user interface elements is specified in a markup language, such as hypertext markup language (HTML) or XML User Interface Language (XUL). The layout of user interface elements is specified in a style sheet language such as Cascading Style Sheets (CSS). Alternatively, interface 111 is specified in one or more other languages, such as Java, C, or C++.

A prompt generation module 113 generates prompts to the generative AI model 114. The prompts direct the generative AI model 114 to generate content. In an embodiment, if the prompt generation module 113 determines a request includes a user or system request to generate a recommended action, the prompt generation module 113 generates a prompt that includes instructions to include resource data for a resource used to generate content.

According to an example embodiment, the prompt generation module 113 generates a prompt that includes information about resources, including data resources 141 and computing resources 120, available in a system 100. The resources may be available to clients, including the client 130, for performing functions in the system. Example functions include viewing, editing, and generating content, including data objects, documents, and data files. Functions may include modifying data structures, setting alarms and notifications, generating calendar entries, and generating and/or sending communications to accounts and users.

According to an example embodiment, the prompt generation module 113 obtains information about resources to include in a prompt based on displayed data when a request is received. For example, if a GUI displays a project proposal when a user selects an interface element to direct an AI model to generate content, the system generates a prompt that includes project applications, such as scheduling applications, financial applications, data management and prognostication applications, and personnel management applications. The resources included in the prompt may include resources that are supported by an entity associated with displayed data. As another example, if a GUI displays computing system configuration data when a user selects an interface element to direct an AI model to generate content, the system generates a prompt that includes system specification data and system configuration applications.

In one or more embodiments, the prompt generation module 113 includes recommendations 142 from previously generated responses that were generated by the generative AI model 114. The prompt may include an instruction to generate a recommended action different from one or more previously recommended actions. Accordingly, the generative AI model access platform 110 may avoid redundant or overly repetitive recommendations.

A generative AI model 114 generates content based on the prompt received from the prompt generation module 113. The generative AI model 114 is trained on a broad corpus of data to generate content based on input prompts. According to one embodiment, the generative AI model 114 is further fine-tuned to generate content that includes reference to a particular set of resources for performing particular actions. The particular set of resources may include, for example, proprietary resources utilized by a company, such as a project proposal development platform, a word processing platform, a scheduling platform, a personnel management platform, a product development platform, and a computing resources management platform.

A machine learning engine 115 prepares data to be provided to the generative AI model 114. In an embodiment where the generative AI model 114 is fine-tuned on particular resources, such as a set of system tools available to an entity associated with a request, the machine learning engine 115 may train a fine-tuning head of the generative AI model.

FIG. 1B illustrates an example of a machine learning engine 115. As illustrated in FIG. 1B, machine learning engine 115 includes input/output module 151, data preprocessing module 152, model selection module 153, training module 154, evaluation and tuning module 155, and inference module 156.

In accordance with an embodiment, input/output module 151 serves as the primary interface for data entering and exiting the system, managing the flow and integrity of data. This module may accommodate a wide range of data sources and formats to facilitate integration and communication within the machine learning architecture.

In an embodiment, an input handler within input/output module 151 includes a data ingestion framework capable of interfacing with various data sources, such as databases, APIs, file systems, and real-time data streams. This framework is equipped with functionalities to handle different data formats (e.g., CSV, JSON, XML) and efficiently manage large volumes of data. It includes mechanisms for batch and real-time data processing that enable the input/output module 151 to be versatile in different operational contexts, whether processing historical datasets or streaming data.

In accordance with an embodiment, input/output module 151 manages data integrity and quality as it enters the system by incorporating initial checks and validations. These checks and validations ensure that incoming data meets predefined quality standards, like checking for missing values, ensuring consistency in data formats, and verifying data ranges and types. This proactive approach to data quality minimizes potential errors and inconsistencies in later stages of the machine learning process.

In an embodiment, an output handler within input/output module 151 includes an output framework designed to handle the distribution and exportation of outputs, predictions, or insights. Using the output framework, input/output module 151 formats these outputs into user-friendly and accessible formats, such as reports, visualizations, or data files compatible with other systems. Input/output module 151 also ensures secure and efficient transmission of these outputs to end-users or other systems in an embodiment and may employ encryption and secure data transfer protocols to maintain data confidentiality.

In accordance with an embodiment, data preprocessing module 152 transforms data into a format suitable for use by other modules in machine learning engine 115. For example, data preprocessing module 152 may transform raw data into a normalized or standardized format suitable for training ML models and for processing new data inputs for inference. In an embodiment, data preprocessing module 152 acts as a bridge between the raw data sources and the analytical capabilities of machine learning engine 115.

In an embodiment, data preprocessing module 152 begins by implementing a series of preprocessing steps to clean, normalize, and/or standardize the data. This involves handling a variety of anomalies, such as managing unexpected data elements, recognizing inconsistencies, or dealing with missing values. Some of these anomalies can be addressed through methods like imputation or removal of incomplete records, depending on the nature and volume of the missing data. Data preprocessing module 152 may be configured to handle anomalies in different ways depending on context. Data preprocessing module 152 also handles the normalization of numerical data in preparation for use with models sensitive to the scale of the data, like neural networks and distance-based algorithms. Normalization techniques, such as min-max scaling or z-score standardization, may be applied to bring numerical features to a common scale, enhancing the model's ability to learn effectively.

In an embodiment, data preprocessing module 152 includes a feature encoding framework that ensures categorical variables are transformed into a format that can be easily interpreted by machine learning algorithms. Techniques like one-hot encoding or label encoding may be employed to convert categorical data into numerical values, making them suitable for analysis. The module may also include feature selection mechanisms, where redundant or irrelevant features are identified and removed, thereby increasing the efficiency and performance of the model.

In accordance with an embodiment, when data preprocessing module 152 processes new data for inference, data preprocessing module 152 replicates the same preprocessing steps to ensure consistency with the training data format. This helps to avoid discrepancies between the training data format and the inference data format, thereby reducing the likelihood of inaccurate or invalid model predictions.

In an embodiment, model selection module 153 includes logic for determining the most suitable algorithm or model architecture for a given dataset and problem. This module operates in part by analyzing the characteristics of the input data, such as its dimensionality, distribution, and the type of problem (classification, regression, clustering, etc.).

In an embodiment, model selection module 153 employs a variety of statistical and analytical techniques to understand data patterns, identify potential correlations, and assess the complexity of the task. Based on this analysis, it then matches the data characteristics with the strengths and weaknesses of various available models. This can range from simple linear models for less complex problems to sophisticated deep learning architectures for tasks requiring feature extraction and high-level pattern recognition, such as image and speech recognition.

In an embodiment, model selection module 153 utilizes techniques from the field of Automated Machine Learning (AutoML). AutoML systems automate the process of model selection by rapidly prototyping and evaluating multiple models. They use techniques like Bayesian optimization, genetic algorithms, or reinforcement learning to explore the model space efficiently. Model selection module 153 may use these techniques to evaluate each candidate model based on performance metrics relevant to the task. For example, accuracy, precision, recall, or F1 score may be used for classification tasks and mean squared error metrics may be used for regression tasks. Accuracy measures the proportion of correct predictions (both positive and negative). Precision measures the proportion of actual positives among the predicted positive cases. Recall (also known as sensitivity) evaluates how well the model identifies actual positives. F1 Score is a single metric that accounts for both false positives and false negatives. The mean squared error (MSE) metric may be used for regression tasks. MSE measures the average squared difference between the actual and predicted values, providing an indication of the model's accuracy. A lower MSE may indicate a model's greater accuracy in predicting values, as it represents a smaller average discrepancy between the actual and predicted values.

In accordance with an embodiment, model selection module 153 also considers computational efficiency and resource constraints. This is meant to help ensure the selected model is both accurate and practical in terms of computational and time requirements. In an embodiment, certain features of model selection module 153 are configurable such as a configured bias toward (or against) computational efficiency.

In accordance with an embodiment, training module 154 manages the ‘learning’ process of ML models by implementing various learning algorithms that enable models to identify patterns and make predictions or decisions based on input data. In an embodiment, the training process begins with the preparation of the dataset after preprocessing; this involves splitting the data into training and validation sets. The training set is used to teach the model, while the validation set is used to evaluate its performance and adjust parameters accordingly. Training module 154 handles the iterative process of feeding the training data into the model, adjusting the model's internal parameters (like weights in neural networks) through backpropagation and optimization algorithms, such as stochastic gradient descent or other algorithms providing similarly useful results.

In accordance with an embodiment, training module 154 manages overfitting, where a model learns the training data too well, including its noise and outliers, at the expense of its ability to generalize to new data. Techniques such as regularization, dropout (in neural networks), and early stopping are implemented to mitigate this. Additionally, the module employs various techniques for hyperparameter tuning; this involves adjusting model parameters that are not directly learned from the training process, such as learning rate, the number of layers in a neural network, or the number of trees in a random forest.

In an embodiment, training module 154 includes logic to handle different types of data and learning tasks. For instance, it includes different training routines for supervised learning (where the training data comes with labels) and unsupervised learning (without labeled data). In the case of deep learning models, training module 154 also manages the complexities of training neural networks that include initializing network weights, choosing activation functions, and setting up neural network layers.

In an embodiment, evaluation and tuning module 155 incorporates dynamic feedback mechanisms and facilitates continuous model evolution to help ensure the system's relevance and accuracy as the data landscape changes. Evaluation and tuning module 155 conducts a detailed evaluation of a model's performance. This process involves using statistical methods and a variety of performance metrics to analyze the model's predictions against a validation dataset. The validation dataset, distinct from the training set, is instrumental in assessing the model's predictive accuracy and its capacity to generalize beyond the training data. The module's algorithms meticulously dissect the model's output, uncovering biases, variances, and the overall effectiveness of the model in capturing the underlying patterns of the data.

In an embodiment, evaluation and tuning module 155 performs continuous model tuning by using hyperparameter optimization. Evaluation and tuning module 155 performs an exploration of the hyperparameter space using algorithms, such as grid search, random search, or more sophisticated methods like Bayesian optimization. Evaluation and tuning module 155 uses these algorithms to iteratively adjust and refine the model's hyperparameters—settings that govern the model's learning process but are not directly learned from the data—to enhance the model's performance. This tuning process helps to balance the model's complexity with its ability to generalize and attempts to avoid the pitfalls of underfitting or overfitting.

In an embodiment, evaluation and tuning module 155 integrates data feedback and updates the model. Evaluation and tuning module 155 actively collects feedback from the model's real-world applications, an indicator of the model's performance in practical scenarios. Such feedback can come from various sources depending on the nature of the application. For example, in a user-centric application like a recommendation system, feedback might comprise user interactions, preferences, and responses. In other contexts, such as predicting events, it might involve analyzing the model's prediction errors, misclassifications, or other performance metrics in live environments.

In an embodiment, feedback integration logic within evaluation and tuning module 155 integrates this feedback using a process of assimilating new data patterns, user interactions, and error trends into the system's knowledge base. The feedback integration logic uses this information to identify shifts in data trends or emergent patterns that were not present or inadequately represented in the original training dataset. Based on this analysis, the module triggers a retraining or updating cycle for the model. If the feedback suggests minor deviations or incremental changes in data patterns, the feedback integration logic may employ incremental learning strategies, fine-tuning the model with the new data while retaining its previously learned knowledge. In cases where the feedback indicates significant shifts or the emergence of new patterns, a more comprehensive model updating process may be initiated. This process might involve revisiting the model selection process, re-evaluating the suitability of the current model architecture, and/or potentially exploring alternative models or configurations that are more attuned to the new data.

In accordance with an embodiment, throughout this iterative process of feedback integration and model updating, evaluation and tuning module 155 employs version control mechanisms to track changes, modifications, and the evolution of the model, facilitating transparency and allowing for rollback if necessary. This continuous learning and adaptation cycle, driven by real-world data and feedback, helps to endure the model's ongoing effectiveness, relevance, and accuracy.

In an embodiment, inference module 156 transforms data raw data into actionable, precise, and contextually relevant predictions. In addition to processing and applying a trained model to new data, inference module 156 may also include post-processing logic that refines the raw outputs of the model into meaningful insights.

In an embodiment, inference module 156 includes classification logic that takes the probabilistic outputs of the model and converts them into definitive class labels. This process involves an analytical interpretation of the probability distribution for each class. For example, in binary classification, the classification logic may identify the class with a probability above a certain threshold, but classification logic may also consider the relative probability distribution between classes to create a more nuanced and accurate classification.

In an embodiment, inference module 156 transforms the outputs of a trained model into definitive classifications. Inference module 156 employs the underlying model as a tool to generate probabilistic outputs for each potential class. It then engages in an interpretative process to convert these probabilities into concrete class labels.

In an embodiment, when inference module 156 receives the probabilistic outputs from the model, it analyzes these probabilities to determine how they are distributed across some or every potential class. If the highest probability is not significantly greater than the others, inference module 156 may determine that there is ambiguity or interpret this as a lack of confidence displayed by the model.

In an embodiment, inference module 156 uses thresholding techniques for applications where making a definitive decision based on the highest probability might not suffice due to the critical nature of the decision. In such cases, inference module 156 assesses if the highest probability surpasses a certain confidence threshold that is predetermined based on the specific requirements of the application. If the probabilities do not meet this threshold, inference module 156 may flag the result as uncertain or defer the decision to a human expert.

Inference module 156 dynamically adjusts the decision thresholds based on the sensitivity and specificity requirements of the application, subject to calibration for balancing the trade-offs between false positives and false negatives.

In accordance with an embodiment, inference module 156 contextualizes the probability distribution against the backdrop of the specific application. This involves a comparative analysis, especially in instances where multiple classes have similar probability scores, to deduce the most plausible classification. In an embodiment, inference module 156 may incorporate additional decision-making rules or contextual information to guide this analysis, ensuring that the classification aligns with the practical and contextual nuances of the application.

In regression models, where the outputs are continuous values, inference module 156 may engage in a detailed scaling process in an embodiment. Outputs, often normalized or standardized during training for optimal model performance, are rescaled back to their original range. This rescaling involves recalibration of the output values using the original data's statistical parameters, such as mean and standard deviation, ensuring that the predictions are meaningful and comparable to the real-world scales they represent.

In an embodiment, inference module 156 incorporates domain-specific adjustments into its post-processing routine. This involves tailoring the model's output to align with specific industry knowledge or contextual information. For example, in financial forecasting, inference module 156 may adjust predictions based on current market trends, economic indicators, or recent significant events, ensuring that the outputs are both statistically accurate and practically relevant.

In an embodiment, inference module 156 includes logic to handle uncertainty and ambiguity in the model's predictions. In cases where inference module 156 outputs a measure of uncertainty, such as in Bayesian inference models, inference module 156 interprets these uncertainty measures by converting probabilistic distributions or confidence intervals into a format that can be easily understood and acted upon. This provides users with both a prediction and an insight into the confidence level of that prediction. In an embodiment, inference module 156 includes mechanisms for involving human oversight or integrating the instance into a feedback loop for subsequent analysis and model refinement.

In an embodiment, inference module 156 formats the final predictions for end-user consumption. Predictions are converted into visualizations, user-friendly reports, or interactive interfaces. In some systems, like recommendation engines, inference module 156 also integrates feedback mechanisms, where user responses to the predictions are used to continually refine and improve the model, creating a dynamic, self-improving system.

Referring to FIG. 1A, in an embodiment, machine learning engine API 117 allows for applications to leverage machine learning engine 115. In an embodiment, machine learning engine API 117 may be built on a RESTful architecture and offer stateless interactions over standard HTTP/HTTPS protocols. Machine learning engine API 117 may feature a variety of endpoints, each tailored to a specific function within machine learning engine 115. In an embodiment, endpoints such as /submitData facilitate the submission of new data for processing, while /retrieveResults is designed for fetching the outcomes of data analysis or model predictions. The MLE API may also include endpoints like /updateModel for model modifications and /trainModel to initiate training with new datasets.

In an embodiment, machine learning engine API 117 is equipped to support SOAP-based interactions. This extension involves defining a WSDL (Web Services Description Language) document that outlines the API's operations and the structure of request and response messages. In an embodiment, machine learning engine API 117 supports various data formats and communication styles. In an embodiment, machine learning engine API 117 endpoints may handle requests in JSON format or any other suitable format. For example, machine learning engine API 117 may process XML, and it may also be engineered to handle more compact and efficient data formats, such as Protocol Buffers or Avro, for use in bandwidth-limited scenarios.

In an embodiment, machine learning engine API 117 is designed to integrate WebSocket technology for applications necessitating real-time data processing and immediate feedback. This integration enables a continuous, bi-directional communication channel for a dynamic and interactive data exchange between the application and machine learning engine 115.

In one or more embodiments, the machine learning engine 115 trains a fine-tuning head of the generative AI model 114 to generate content based on a specified set of system resources, such as particular data resources 141 and particular computing resources 120, including devices and applications running on devices.

A generative model is a machine learning model that is capable of generating new data instances based on the data used to train the model. In the present specification, a generative model may be referred to as a “generative artificial intelligence (AI) model.” Generative models learn the underlying distribution of the training data, enabling them to produce new instances of data that share properties with the original dataset. This capability makes them particularly useful in a variety of applications, including image and voice generation, text synthesis, and more sophisticated tasks, like unsupervised learning, semi-supervised learning, and domain adaptation.

One type of generative model is a large language model (LLM). Large language models (LLMs) are designed to understand, generate, and interpret human language by processing extensive collections of data. The foundational architecture behind LLMs is the transformer network, a type of neural network that excels in handling sequential data such as text. Unlike architectures, such as recurrent neural networks (RNNs) or long short-term memory networks (LSTMs), transformers do not process data in order. Instead, they leverage parallel processing to analyze entire text sequences simultaneously, significantly improving efficiency and reducing training times. In one embodiment, the generative AI model 114 is an LLM.

In an embodiment, a mechanism that enables transformers to handle complex language tasks is self-attention. This mechanism allows the model to weigh the importance of different words within a sentence or sequence regardless of their position. For instance, in processing the phrase “The cat sat on the mat,” the model can directly associate “cat” with “mat” without having to process the intermediate words sequentially. This ability to understand the context and relationships between words in a sentence is what makes transformer networks adept at language tasks. The self-attention mechanism assigns scores to relationships between words, highlighting the most relevant connections, so the model can focus on the most informative parts of the text.

In accordance with one or more embodiments, transformers are composed of multiple layers containing a multi-head, self-attention mechanism and a position-wise, feed-forward network. Within the architecture of transformer models, the multi-head, self-attention mechanism and position-wise, feed-forward network function in concert to process input data. The multi-head, self-attention mechanism is designed to enable parallel processing of input sequences, allowing the model to simultaneously evaluate the importance of different segments of the input relative to each other. This mechanism operates by generating multiple sets of query, key, and value vectors for each element in the input sequence through linear transformation. The relevance of each element to every other element is calculated using a scaled, dot-product attention function that computes the attention scores by taking the dot product of the query vector with the key vectors, dividing each by the square root of the dimension of the key vectors to scale the scores, then applying a SoftMax function to obtain the weights for the value vectors. The scaled, dot-product attention function is applied independently by each head in the multi-head, self-attention mechanism. The outputs of these heads are then concatenated and linearly transformed, allowing the model to capture information from different representation subspaces.

In accordance with one or more embodiments, following the multi-head, self-attention mechanism is the position-wise, feed-forward network. This component comprises two linear transformations with a non-linear activation function in between. Each element of the input sequence, now enriched with context by the self-attention mechanism, is processed independently through the same feed-forward network. The first linear transformation increases the dimensionality of the input, allowing for a richer representation space. The non-linear activation function introduces the capability to capture non-linear relationships within the data. The second linear transformation then reduces the dimensionality back to that of the model's hidden layers, preparing the output for either further processing by subsequent layers or final output generation. This sequence of operations is applied to each position in the sequence, so the model can learn complex patterns across different parts of the input data without relying on the sequential processing inherent to previous architectures, such as RNNs or LSTMs.

In accordance with one or more embodiments, integrating these components within the transformer architecture facilitates the model's ability to understand and generate human language by leveraging both the global context provided by the self-attention mechanism and the local, position-specific transformations applied by the feed-forward networks. Through the repetitive stacking of layers, transformers achieve a depth of representation that allows for the processing of linguistic information across varying levels of complexity.

In accordance with one or more embodiments, input/output module 151 (described in FIG. 1B), when used for LLMs, handles textual data and converts input text into a format that the model can process. This typically involves tokenization, where the text is broken down into manageable pieces, such as words or sub-words, and then converted into numerical representations. These representations, or embeddings, capture semantic information about the text that is then fed into the model for processing. The output from the model is converted from numerical form back into human-readable text, following the generation of predictions or responses.

In accordance with one or more embodiments, data preprocessing module 152 (described in FIG. 1B) in the context of LLMs may include steps, such as normalization, where the text is converted to a uniform case and punctuation is standardized. This process ensures that the model treats similar words or symbols consistently, reducing the complexity of the input space. Additionally, techniques, such as sentence segmentation, may be applied to manage longer texts, enabling the model to process information in chunks that align with natural language structures.

In accordance with one or more embodiments, model selection module 153 (described in FIG. 1B), when used for LLMs, involves choosing a specific architecture and configuration that is best suited to the task at hand. This decision is based on various factors, such as the size of the available training data, the complexity of the language tasks to be performed, and computational resource constraints. Models may vary in size from millions to billions of parameters, with larger models generally capable of more nuanced language understanding and generation but requiring significantly more computational power to train and operate.

In accordance with one or more embodiments, training module 154 (described in FIG. 1B), when used for LLMs, is configured to adjust the model's parameters through exposure to training data. This process utilizes optimization algorithms, such as stochastic gradient descent, to minimize the difference between the model's predictions and the actual desired outputs. The training process is computationally intensive, often requiring specialized hardware, such as Graphics Processing Units (GPUs) or Tensor Processing Units (TPUs), to manage the large volumes of data and the complexity of the model calculations. During training, techniques, such as dropout and layer normalization, are used to improve model generalization and prevent overfitting (i.e., when a model learns the detail and noise in the training data to the extent that it negatively impacts the model's performance on new data).

In accordance with one or more embodiments, evaluation and tuning module 155 assesses the performance of LLMs using various metrics, such as perplexity, accuracy, and F1 score, depending on the specific language tasks. Evaluation may involve comparing the model's output against a set of labeled validation data, providing insight into how well the model has learned to perform tasks, such as text classification, question answering, or text generation. Tuning involves adjusting model parameters or training strategies based on evaluation outcomes to improve performance. This may include hyperparameter tuning, where parameters that govern the training process, such as learning rate or batch size, are adjusted.

In accordance with one or more embodiments, inference module 156, in the context of LLMs, is responsible for generating predictions or responses based on new, unseen data. This process involves feeding the input data through the trained model to produce an output. Inference can be used for a variety of applications, including translating text, generating human-like responses in a chatbot, or summarizing articles.

As illustrated in FIG. 1C, in an embodiment, the generative AI model 114 is a transformer-type machine learning model. The generative AI model 114 includes a set of encoder stacks 161 and a set of decoder stacks 164. Each encoder stack in the set of encoder stacks 161 includes a multi-attention head mechanism 162 and a feed-forward neural network 163. Each decoder stack in the set of decoder stacks 164 includes a multi-attention head mechanism 165, a feed-forward neural network 166, and a fine-tuning head 167 for generating remediation record anomaly predictions. In one embodiment, the generative AI model 114 is a fine-tuned LLM. While the fine-tuning head 167 is illustrated in FIG. 1C as being added to an output for the decoder stacks 164, in one or more embodiments, the fine-tuning head 167 is added to an output of the encoder stacks 161. The decoder stacks 164 may receive the output from the encoder stacks 161 and the fine-tuning head 167 to generate a human-understandable output.

The encoders in the set of encoder stacks 161 include multi-attention heads 162 that provide a self-attention mechanism. Likewise, decoders in the set of decoder stacks 164 include multi-head attention mechanisms 165. The attention mechanism dynamically determines weights for elements of input tokens of an input vector based on input queries and element keys. The result of the attention mechanism is a combined representation of an input sequence. The generative AI model 114 generates the combined representation by concatenating the outputs from multiple attention heads, where each attention head focuses on different aspects of the input sequence. The generative AI model 114 then applies a linear transformation to the concatenated output. The multi-attention head 162 allows the encoder 161 to simultaneously focus on different aspects of an input sequence by running multiple independent attention mechanisms (i.e., “heads”) in parallel. Focusing on different aspects of the set of input elements allows the encoder 161 to encode embeddings representing input data with additional data representing relationships between elements within the set of input data elements.

The feed-forward neural network 163 converts the output from the multi-head attention mechanism 162 into a set of output sequences that include a word vector embedding sequence and a positional encoder sequence. The word vector embeddings are numerical representations of text. The positional encoding sequence represents the relative positions of words in the word vector embedding sequence. Each sub-layer of the encoder stacks 161 receives an output from the previous sub-layer and applies the attention mechanism 162 and neural network 163 to the output from the previous sub-layer to generate a new output embedding representing the input sequence. Likewise, each sub-layer of the decoder stacks 164 receives an output from the previous sub-layer and applies the attention mechanism 165 and neural network 166 to the output from the previous sub-layer to generate a new output embedding representing the input sequence. Unlike the encoder stacks 161, the final layer of the decoder stacks 164 outputs a sequence of words instead of an embedding representing the input sequence.

The generative AI model 114 includes a fine-tuning head for generating content directed to system resources, including data resources 141 and computing resources. For example, a user may interact with a project proposal application to request the generative AI model 114 to generate project proposal content. While the neural networks 163 and 166 of the generative AI model 114 may be trained on a broad corpus of data, the fine-tuning head 167 may be trained on historical project proposals associated with a particular company. The fine-tuning head 167 may learn, based on training, particular resources available to the company, such as project data, sales data, prediction data, corresponding applications, and example structures or formats of project proposals.

In one embodiment, one or more final layers of the final decoder stack among the decoder stacks 164 is removed. A new set of neural layers is added to the final, feed-forward neural network 166. The generative AI model 114 is then re-trained on a dataset that includes historical software artifacts, such as documents and webpages, that specify system resources. However, in retraining the model, each neural layer of each neural network 163 and 166, other than the fine-tuning head 167, is frozen. In other words, the model maintains constant the parameters (e.g., offsets and weights) of the neurons in the neural networks 163 and 166 other than the parameters of the neurons in the fine-tuning head 167. In another embodiment, the fine-tuning head 167 is appended to the final layer of the final, feed-forward neural network 166 without removing any layers from the final, feed-forward neural network 166. In yet another embodiment, one or more final layers of the final encoder stack, among the encoder stacks 161, is removed. A new set of neural layers (i.e., the fine-tuning head 167) is added to the final, feed-forward neural network 163. The generative AI model 114 is then re-trained on the dataset described above.

Referring to FIG. 1A, the generative AI model 114 generates content that includes recommended actions based on a set of input parameters specified in a prompt. The content further specifies one or more resources relied on by the generative AI model to generate the recommended actions.

The training dataset 144 includes training records for training a neural network such as the fine-tuning head of the generative AI model 114. In an example where the model is trained to generate content for a project proposal, the training dataset includes historical project proposals, including historically recommended actions.

A generative AI response enrichment module 116 analyzes the response generated by the generative AI model 114 to identify recommended actions. The generative AI response enrichment module 116 may include a content parsing module for parsing the response to identify words associated with an action. In one example embodiment, the generative AI response enrichment module 116 includes a semantic analysis module. In another example embodiment, the generative AI response enrichment module 116 generates a follow-up prompt to the generative AI model 114 with instructions to identify the recommended action in the response. In some embodiments, the system 100 uses the same generative AI model 114, or another generative AI model, to identify the portions of response that relate to performing a recommended action.

The generative AI response enrichment module 116 analyzes the generative AI response to identify a resource associated with the recommended action. Resources may include stored data, applications, and devices. The generative AI response enrichment module 116 identifies a relationship between recommended actions and functions that are associated with the resources. For example, a recommendation to monitor a project status may correspond to a function in a project management application to generate alerts based on attributes of a project. A recommendation to increase processing resources in a computing system may correspond to a function in a cloud management application to assign additional cloud resources to an entity. A recommendation to address missing timecards may correspond to a function to open a service ticket in a personnel management application.

The generative AI response enrichment module 116 includes a software module that generates segments of software code to add to the generative AI response. The segments of software code, when executed, initiate functions associated with resources. For example, a segment of software code may correspond to a hyperlink displayed in a document or webpage. The segment of software code may direct a user interface to an application for executing a recommended action. Additionally, or alternatively, the set of software code may initiate execution of the recommended action using the resource.

Additional embodiments and/or examples relating to computer networks are described below in Section 6, titled “Computer Networks and Cloud Networks.”

### 3. Generating Selectable Links in Ai-Generated Content to Implement Recommended Actions

FIGS. 2A and 2B illustrate an example set of operations for generating selectable links to implement recommended actions in AI-generated content in accordance with one or more embodiments. One or more operations illustrated in FIGS. 2A and 2B may be modified, rearranged, or omitted. Accordingly, the sequence of operations illustrated in FIGS. 2A and 2B should not be construed as limiting the scope of one or more embodiments.

Referring to FIG. 2A, in an embodiment, the system receives a request to use a generative AI model to generate content (Operation 202). In one example, the system detects a trigger to generate generative AI model action recommendations. For example, a user may select an interface element of a graphical user interface (GUI). The interface element may present text to “generate program insights” or “generate program recommendations.” The interface element may be linked to software code to initiate a sequence of operations to generate a program summary and project insights.

In one embodiment, a request to generate content by a generative AI model may be associated with a program managed by an entity such as a company. The program may be a collection of projects that share a common strategic objective. For example, a program may include managing a product line. One project may be to develop a new product in the product line. The project may involve one or more teams that conduct research, develop specifications for the new product, and develop a prototype or working example of the product. Another project may include customer acquisition for an existing product. Tasks in a customer acquisition product may include managing a database of potential customers, conducting pitches to potential customers, and running an advertising campaign. Another project may include upgrading an existing product. Tasks in a project to upgrade an existing product may include identifying specifications for the upgrade, testing, and rollout. Examples of types of programs include programs to create, develop, maintain, and upgrade goods and devices, services, and software applications such as financial applications.

In addition to user input, a request may be received responsive to other triggers, including detecting program metrics that meet a recommendation threshold. For example, a system may monitor the status of a set of projects in a program. The system may be configured with thresholds for performance metrics, such as total revenue, change in revenue year-over-year, profit, and costs to maintain a project. An application may generate a request based on determining that one or more metrics (such as total revenue) for any project fall below a threshold, that one or more metrics exceed a threshold, or that a set of metrics for a threshold number of projects in the program fall below or exceed a performance threshold.

The system determines if the request includes a request to generate an action recommendation (Operation 204). The system may parse the request to identify particular words and phrases associated with requesting an action recommendation. Additionally, or alternatively, the system may apply a semantic analysis model to the request to determine if the request includes a request for an action recommendation.

If the system determines the request does not include a request for an action recommendation, the system generates a prompt for the generative AI model based on the request (Operation 206). The system may pass the request to the generative AI model without modifying the request.

If the system determines the request includes a request for an action recommendation, the system generates a prompt for the generative AI model with instructions for the generative AI model to specify resources used to generate a recommended action (Operation 208). In one embodiment, a generative AI model is trained on a broad corpus of text. The prompt includes system data, including resources available in the system. In another embodiment, the generative AI model is fine-tuned to generate recommendations based on system-specific resources.

Examples of resources include source data used to generate a recommendation, applications, and system tools associated with performing recommended actions. Source data include performance data, monitored data, and other data used to generate a recommendation. In one example, the system identifies a program associated with the request. The system identifies source data associated with the program. For example, the system may identify program metrics that measure performance of the program. A system may identify metric log files, reports, and tables associated with a program and the projects that make up the program. According to one example, a program may include three projects: ABC Co. Application Upgrade, DEF Co. Application Implementation, and GHI Co. Application Implementation. For each project, the system may store source data, including the following: budget, expenses, income, revenue, margin, invoices sent, and/or payments received.

In one or more embodiments, source data includes program and project metrics. Program and project metrics include any measurable data related to the performance of the program and project. In addition to financial metrics, other metrics include metrics related to a supply chain, such as inventory and deliveries. Other metrics may measure employee and team performance, including salary, number of employees, efficiency, deadlines met, and deadlines missed. Other metrics may measure customer performance, including customer size (e.g., number of employees at a customer company), revenue generated from customer orders, quantity of purchases, invoices paid, invoices unpaid, invoices paid late, etc.

The generative AI model prompt includes an instruction for the generative AI model to generate action recommendations. The action recommendations may include a recommendation to perform an action associated with one or more projects of the program. The instruction may direct the generative AI model to generate several recommendations for a specified number of projects based on predefined criteria. Examples of predefined criteria include program metrics values that meet specified threshold values, defined priority levels, and project milestones. For example, the generative AI model prompt may direct the generative AI model to identify the three projects for which revenue in the previous quarter (a) fell compared to the previous quarter and (b) fell by the highest percentage compared to the same quarter in the previous year. The generative AI model prompt may direct the generative AI model to generate between one and three recommendations for increasing revenue for the three projects.

In an embodiment, the generative AI model prompt includes source data access information to allow the generative AI model to access a set of source data to generate recommendations and summaries. The source data may include proprietary data or data maintained by a company or entity initiating the recommendation request. The source data access information may include address information where data is stored. The source data access information includes information to allow users to initiate actions included in a recommendation by interacting with the recommendation. For example, if a recommendation includes the content “enter invoice data from missing invoices,” the source data access information includes a storage address of invoices.

In one or more embodiments, the generative AI model prompt further references metadata describing attributes of source data. For example, the system may identify where data associated with a set of program metrics is stored, the type of data the metric measures, and the type of value the metric represents. If the program metrics include a revenue metric, the system may provide an address to a storage location that stores a table of revenue over time for a set of projects that make up the program. If the program metrics include an invoices unpaid metric, the system may provide in the generative AI model prompt an address to a set of data describing the paid/unpaid status of invoices. In one embodiment, the source data may be stored in tables in a database. The generative AI model prompt may include query language to initiate a query to the database. As another example, the source data may be stored as tables in a file system. The generative AI model prompt may include an address of the files stored in the file system. According to yet another example, source data may be stored on a webpage. The generative AI model prompt may include a uniform resource locator (URL) to the webpage.

One or more embodiments provide attribute data describing program metrics to the generative AI model. The system provides the generative AI model, in the prompt, with a dictionary of metrics and a natural language explanation of what the metric measures are. The dictionary may be stored as metadata that describes the metrics data. Accordingly, the generative AI model may generate summaries and recommendations for different entities that use different terms for a particular feature or that use the same term for different features.

In one or more embodiments, the prompt includes an instruction for the generative AI model to specify resources used to generate the recommended actions. For example, the generative AI model may access a particular type of source data to generate a recommendation to monitor that type of source data. The instruction directing the generative AI model to specify the resources used to generate the recommended action would result in the generative AI model identifying the particular source data used to generate the recommendation.

In one or more embodiments, the generative AI model prompt directs the generative AI model to generate a summary of a program. The summary of the program describes the program's status at a high level. For example, the summary may explain that the program is increasing in revenue or decreasing in revenue year-over-year. The summary may describe some projects as meeting deliverable goals and one or more projects as failing to meet deliverable goals. In one or more embodiments, the generative AI model prompt includes an instruction to generate one or more graphs to depict the content described in the project summary. The generative AI model prompt directs the generative AI model to generate separate descriptions for separate projects that make up the program. The generative AI model prompt may direct the generative AI model to describe the projects in terms of program metrics.

Based on the prompt, the generative AI model generates content that includes one or more action recommendations. The system receives a response from the generative AI model that includes one or more recommended actions and a description of a resource used to generate the recommendation (Operation 210). For example, the generative AI model may generate text content that includes a program summary, a set of notable projects in the program, and recommendations for improving performance of the projects. A project summary may include a natural language description of the program. The description may include an indicator of the status of the program, such as if the program is performing as expected, better than predicted, or worse than predicted. The description may reference program metrics across the set of projects that make up the program. The description may describe the program as meeting revenue targets but falling in revenue compared to the previous quarter and dealing with increased costs. The description of the set of projects may reference program metrics. Continuing with the example in which the program metrics include revenue, costs, and margins, the project description may include a description of the revenue, costs, and margins for the project. The recommendations include natural language description of remedial actions to be taken for respective projects. For example, one recommendation may be to “monitor this project's costs closely . . . ”. Another recommendation may be to “correct entries in table of received invoices . . . ”. Yet another recommendation may be to “consider feasibility study to predict this project's performance over the next year . . . ”.

The generative, AI model-generated content further includes a reference to a resource used to generate a recommendation. A resource may include a set of source data. The generative, AI model-generated content may include in its response identifying information of data objects or data tables where the source data is stored. The identifying information may be expressly described in the response. Alternatively, the identifying information may be included as metadata with the response. Additionally, or alternatively, the generative, AI model-generated content may include address information to direct an application to the storage location where the source data is stored.

In some embodiments, the generative AI model generates a recommended action based on existing action plans. For example, the generative AI model prompt may include a reference to a set of action plans describing ongoing tasks. The generative AI model prompt may include an instruction to exclude from a set of recommended actions any recommendation corresponding to an existing action plan or ongoing task, thereby avoiding redundant recommendations. For example, a user may set up a monitor to notify the user of monthly revenue values that fall below a threshold. The generative AI model may identify monitoring revenue values as a candidate recommended action. Based on the generative AI model instruction to exclude redundant recommendations, the generative AI model may omit from any presented recommendations the recommendation to monitor revenue values.

The system analyzes the generative AI model-generated content to identify a recommended action within the content (Operation 212). Identifying the recommended action may include identifying an intent of the text that recommends the action. For example, a recommendation may include the text “Focus on maintaining the project's financial trajectory and ensuring a timeline completion.” Analyzing the text includes parsing the text to determine portions that relate to performing an action. In one embodiment, the system uses a semantic analysis type machine learning model to identify the portions that relate to performing an action. In another embodiment, the system generates a second prompt to a generative AI model directing the generative AI model to identify the portion of the initial response that corresponds to an action recommendation.

Referring to the above example, the system may identify the term “focus on maintaining the project's financial trajectory” as corresponding to one action. The system may identify the terms “ensuring a timely completion” as corresponding to another action. In some instances, identifying the intent of the recommended action includes identifying an action that is not expressly stated in the content. In the example in which the recommended action includes the text “focus on maintaining the project's financial trajectory,” the system identifies the intent of the recommendation as keeping track of revenue and profitability data for the project. A semantic analysis machine learning model or a generative AI model may identify the intent of a recommended action when the generative, AI model-generated content does not expressly state an action associated with a recommendation. In some embodiments, the system uses the same generative AI model, or another generative AI model, to identify the portions of generative, AI model-generated content that relates to performing an action. For example, the system may generate the generative AI model prompt with an instruction to present a recommendation and to label the action in the recommendation with metadata.

Based on identifying one or more recommended actions in a set of generative, AI model-generated content, the system determines resources, including source data, applications, and tools, associated with recommended actions (Operation 214). In one example, the generative AI model may describe the resources based on the instruction included in the generative AI model prompt. The generative AI model may generate a recommended action as well as an identifier associated with a subset of the resources that is associated with the recommended action. For example, the system may identify project financial data as being associated with one action. The system may further identify a financial management application as a component a user may utilize to view and monitor the financial data. The system may further identify project timeline data as corresponding to another action. The system may identify a project management application as a component a user may utilize to monitor project tasks and milestones.

In one or more embodiments, the system identifies a set of resources associated with an intent of the recommended action. Identifying the intent may include determining a type of action being recommended. Based on identifying the intent, the system may map the type of action to a set of resources related to the action and/or an application capable of performing the action. The system may identify address information of an executable file for running an application, navigation data for navigating to a particular GUI in the application, and API endpoint data for initiating, by the system, one or more application functions.

In one example, a generative AI model may generate a recommendation to add one or more program developers to a project to keep the project on schedule. A system parses the recommendation and identifies the action “add personnel.” The system identifies the source data associated with the action. The source data may include personnel data and/or scheduling data. The system may further identify an application that allows a user to modify personnel assignments.

The system determines target functionality associated with resources that enable the user to initiate the recommended actions (Operation 216). The target functionality includes the operations executed by applications to perform the recommended actions. For example, the system may identify a recommended action “review resource availability” in generative, AI model-generated content. The system may determine target functionality in a resource management application that displays a Gantt chart of resource usage in a project.

In one embodiment, the system determines the target functionality by (a) identifying a set of resources identified by the generative AI model for generating a recommended action, (b) determining the intent of the recommended action in the AI response, and (c) determining a relationship between the intent of the recommended action and functions of applications and/or tools associated with the resources.

As discussed above, identifying the intent associated with a recommended action may include applying a semantic model to an AI-generated response, generating an additional prompt to the generative AI model to expressly request identifying the intent of the recommended action, or comparing words associated with the recommended action with words associated with functions of resources.

In one or more embodiments, determining target functionality includes identifying an application or tool that includes functionality to perform operations associated with a recommended action and a corresponding resource. For example, if a recommendation includes a recommended action to monitor a set of data, the system identifies (a) the set of data that is a resource used to generate the recommendation, (b) an action to monitor the data, and (c) a system tool that includes data monitoring functionality for the data set.

According to another example, generative AI content may include a recommendation to increase processing resources available to a workflow executing in a cloud environment. The generative AI model may identify workflow data and project data as resources used to generate the recommendation. The system identifies an increase in processing resources as a recommended action. The system further identifies a cloud resource management application as a system tool associated with the recommended action. The system identifies a resource allocation and redistribution interface in the cloud resource management application as the target functionality associated with the recommended action.

Referring to FIG. 2B, the system augments the generative, AI model-generated content with a selectable link (Operation 218). The system generates the selectable link by generating a software code segment. The software code segment directs a user interface application to a resource associated with performing the target functionality. The system further generates software code to display an interface element. The system further generates software code to navigate to the function-executing resource based on a user selection of the interface element. For example, the system may generate code embedded in a Uniform Resource Locator (URL) to direct a web browser to an application that presents information and interface elements in a hypertext transfer protocol (HTTP) format. In an embodiment, the software code may further initiate the recommended action with the function-executing resource based on the user selection of the interface element. Examples of applications and system tools include project management applications, financial management applications, personnel management applications, data monitoring applications, and computing resource allocation applications.

As an example, the generative AI model may generate a recommendation to review income projections for a project based on resource shortages. The system may identify the action “review income projections.” The system may augment the generative, AI model-generated content with a link to an income-forecasting application. The system may further augment the generative, AI model-generated content with a link to a set of income data that the application may use to generate a forecast.

The system displays the generative, AI model-generated content, including the recommended actions, augmented with the selectable links in a GUI (Operation 220). The system may display a program summary together with the recommended actions and links. The GUI may include a main region and a side panel. The main region may occupy a central portion of the GUI. The system may present the program summary in the main region of the GUI. The system may present the action recommendations with selectable links in the side panel of the GUI. The system may present the selectable links as hyperlinks in the text of the recommendations. Additionally, or alternatively, the system may present the selectable links as interface elements, such as buttons, located above, below, or to the side of the recommendations.

Based on displaying recommendations and a selectable link associated with the recommendations, the system determines if feedback has been received to modify a selectable link (Operation 222). For example, a user may determine that a selectable link navigates a user to a GUI that is not correct for a recommended action. Additionally, or alternatively, a user may determine that a set of source data used to populate one or more fields in the GUI to implement the recommendation is incorrect. As an example, a user may determine that the selectable link included in a recommendation is incorrect because one or more preliminary actions are required to implement the recommended action. The user may determine that the correct GUI for implementing a recommended action is a GUI associated with the preliminary action. If a recommended action involves reassigning personnel to a project, a preliminary action may include identifying personnel availability and obtaining approval from a department head to move personnel from one project to another. Accordingly, a user may identify a first GUI that presents personnel assignments and availability and a second GUI that initiates a request to the department head to permit personnel reassignment. In another example, a user may determine that a GUI pointed to in a recommendation link for monitoring project costs is incorrect. The recommendation link may point to a GUI for viewing project costs. The user may determine that an alternative GUI for creating alerts would be more useful for monitoring project costs. In yet another example, a user may determine that a set of source data used to populate a GUI to implement a recommended action is incorrect. A system may populate the GUI with invoice data corresponding to all invoices. The user may determine if the GUI should be populated with invoice data from a subset of the invoices such as unpaid invoices.

If the system determines that feedback was received, the system modifies a resource associated with a selectable link (Operation 224). Modifying a resource associated with a selectable link may include modifying one or more existing mappings of application functions to application GUIs and source data. Additionally, or alternatively, modifying the source data may include adding one or more new mappings of application functions to application GUIs and source data. Referring to the above example where a user determines a GUI should be populated with unpaid invoices, the system may add a new mapping for an action to view unpaid invoices that includes the GUI and filter data for filtering a data set of invoices to include unpaid invoices.

If the system does not receive feedback to modify source data associated with a selectable link, the system determines if a selectable link has been selected (Operation 226). A user may select a link by interacting with a selectable element in a GUI.

If the link has been selected, the system executes generated software code to navigate to a resource associated with a recommended action (Operation 228). In an embodiment, the system may initiate a function of the resource associated with the recommended action. For example, the system may open an executable file pointed to in the selectable link to open an application. Navigation data in the selectable link may direct the user to a GUI presented by the application for performing the recommended action. Address data included in the selectable link may access source data that is used to perform the recommended action. The system may populate the GUI with the source data to perform the recommended action on the source data. For example, performing a recommended action based on user selection of a link may include opening an application to view, compare, modify, create, or delete data. Additional actions may include generating alerts or notifications, generating messages to other users, and initiating computer-run operations, such as performing computer-based scans or checks of stored data.

### 4. Fine-Tuning a Generative AI Model

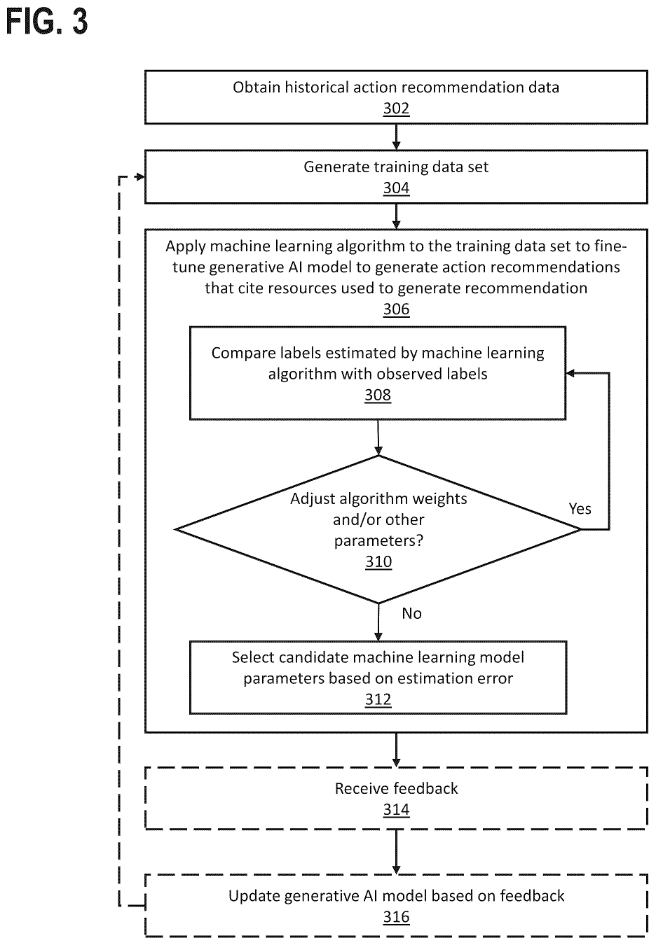

FIG. 3 illustrates an example set of operations for fine-tuning a generative AI model to generate actionable recommendations with citations to particular resources used to generate the recommendations.

In an embodiment, fine-tuning the generative AI model includes adding a fine-tuning head to the pre-trained model by attaching an additional neural network layer to the output of the pre-trained generative AI model such as an LLM model. Adding the fine-tuning head results in generating a different type of output data from the pre-trained model. The pre-trained model is configured to receive sequences of tokens as input data, to generate embeddings for the sequences, and to generate content including recommended actions as output data. The fine-tuning head is configured to receive either the embeddings or the output content from the pre-trained machine learning model as input data and to identify resources used to generate recommendations as output data.

To train the fine-tuning head on the dataset reconciliation data, the system freezes the parameters of the pre-trained machine learning model. The offsets and coefficients of the pre-trained machine learning model are set at their pre-trained values to prevent the parameters from changing in subsequent training of the fine-tuned machine learning model, including the fine-tuning head.

Example operations for fine-tuning the generative AI model are described in FIG. 3. In an embodiment, a system obtains historical action recommendation data (Operation 302). Obtaining the recommendation data may include obtaining historical recommendations specifying recommended actions for a system.

The system uses the historical action recommendation data to generate a training data set (Operation 304). The set of training data includes, for a particular action recommendation, at least one classification label. The classification label may specify one or more resources. For example, an action recommendation to “maintain the project's financial trajectory” may be mapped to a label for “financial data” and to a label for “project management application,” where the project management application has the functionality to monitor financial characteristics and trends of projects.

According to one embodiment, the system obtains the historical data and the training data set from a data repository storing labeled data sets. The training data set may be generated and updated by a machine learning engine or application. Alternatively, the training data set may be generated and maintained by a third party. According to one embodiment, the system generates the labeled set of data by parsing documents and generating labels based on parsed values in the documents. According to an alternative embodiment, one or more users generate labels for a data set.

In some embodiments, generating the training data set includes generating a set of feature vectors for the labeled examples. A feature vector, for example, may be n-dimensional, where n represents the number of features in the vector. The number of features that are selected may vary. The features may be curated in a supervised approach or automatically selected from extracted attributes during model training and/or tuning. Example features include content type, source application of a request to generate content, user requesting content, and actions described in an AI-generated response. In some embodiments, an input is an embedding from a hidden layer of the pre-trained generative AI model, so the input data to the fine-tuning head does not have a direct correlation with particular features. In some embodiments, a feature within a feature vector is represented numerically by one or more bits. The system may convert categorical attributes to numerical representations using an encoding scheme, such as one-hot encoding, label encoding, and binary encoding. One-hot encoding creates a unique binary feature for each possible category in an original feature. In one-hot encoding, when one feature has a value of 1, the remaining features have a value of 0. According to another example, the system may perform label encoding by assigning a unique numerical value to each category. According to yet another example, the system performs binary encoding by converting numerical values to binary digits and creating a new feature for each digit.

The system applies a machine learning algorithm to the training data set to train the machine learning model (Operation 306). Training the machine learning model may include freezing a pre-trained transformer type model and training a fine-tuning head added to the pre-trained model. In one example, a machine learning algorithm may analyze the training data set to train neurons of a neural network with weights and offsets. The weights and offsets associate action recommendations with resources available in a system, including data resources and system tools to be used to perform a recommended action.

The system iteratively applies the machine learning algorithm to sets of action recommendation data in a set of input data to generate an output set of labels, compares the generated labels to pre-generated labels associated with the input data, adjusts weights and offsets of the algorithm based on an error value, and applies the algorithm to another set of event record data.

In some embodiments, the system compares the labels estimated through the one or more iterations of the machine learning model algorithm with observed labels to determine an estimation error (Operation 308). The system may perform this comparison for a test set of examples, which may be a subset of examples in the training dataset that were not used to generate and fit the candidate models. The total estimation error for a particular iteration of the machine learning algorithm may be computed as a function of the magnitude of the difference and/or the number of examples for which the estimated label was wrongly predicted.

In some embodiments, the system determines whether or not to adjust the weights and/or other model parameters based on the estimation error (Operation 310). Adjustments may be made until the system identifies a candidate model that minimizes the estimation error or otherwise achieves a threshold level of estimation error. The process may return to Operation 308 to adjust and continue training the machine learning model.

In some embodiments, the system selects machine learning model parameters based on the estimation error meeting a threshold accuracy level (Operation 312). For example, the system may select a set of parameter values for a machine learning model based on determining that the trained model has an accuracy level for predicting labels for remediation records of at least 98%.

In some embodiments, the system trains a neural network using backpropagation without applying the backpropagation to the pre-trained machine learning model. Backpropagation is a process of updating cell states in the neural network based on gradients determined as a function of the estimation error. With backpropagation, nodes are assigned a fraction of the estimated error based on the contribution to the output and adjusted based on the fraction. In recurrent neural networks, time is also factored into the backpropagation process.

In embodiments in which the machine learning algorithm is a supervised machine learning algorithm, the system may optionally receive feedback on the various aspects of the analysis described above (Operation 314). For example, the feedback may affirm or revise system resource labels generated by the machine learning model. The machine learning model may indicate that a particular action recommendation in an AI-generated response is associated with a label indicating a particular system resource. The system may receive feedback indicating that the particular action recommendation should be associated with a different system resource.

Based on the feedback, the machine learning training set may be updated, thereby improving its analytical accuracy (Operation 316). Once updated, the system may further train the machine learning model by optionally applying the model to additional training data sets.

### 5. Example Embodiment

A detailed example is described below for purposes of clarity. Components and/or operations described below should be understood as one specific example which may not be applicable to certain embodiments. Accordingly, components and/or operations described below should not be construed as limiting the scope of any of the claims.

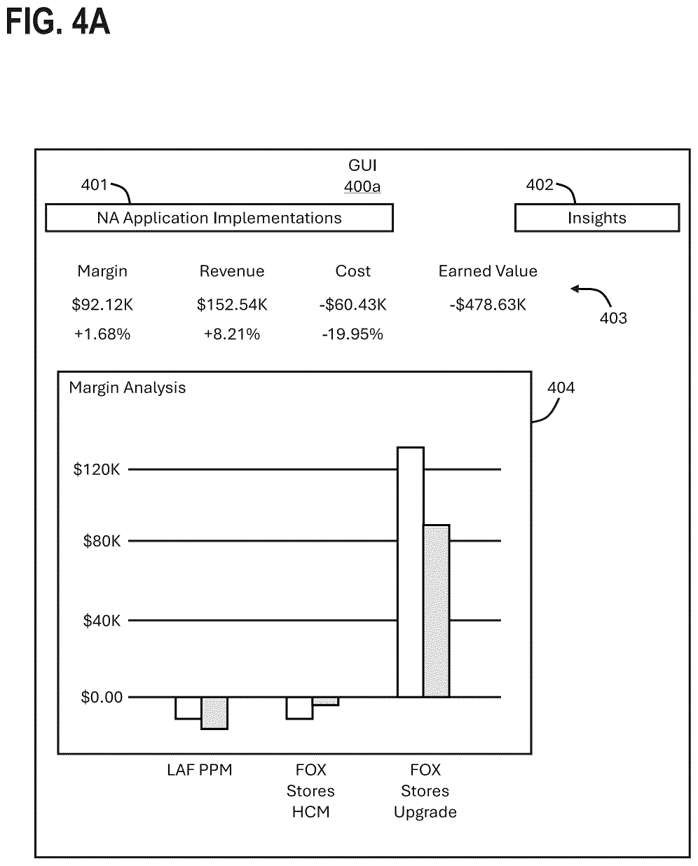

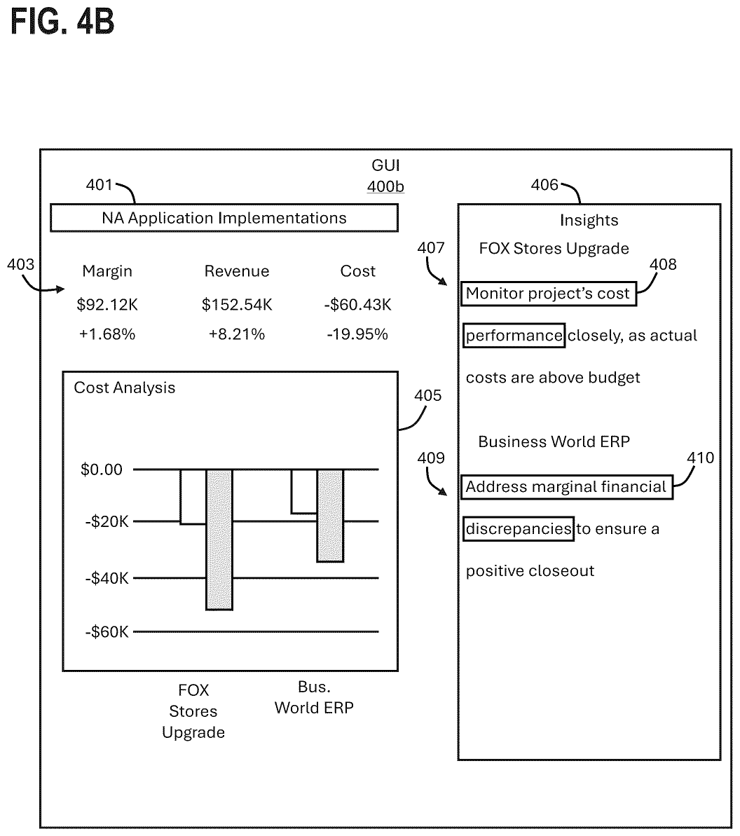

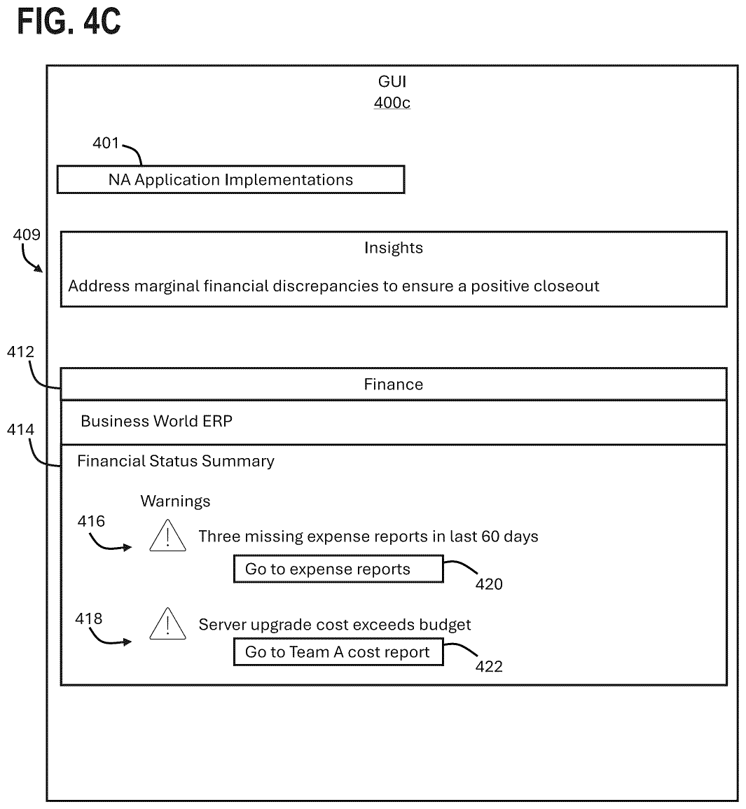

FIGS. 4A-4C illustrate examples of a user interface implementing operations to generate recommendations for applying to projects using artificial intelligence (AI).

As illustrated in FIG. 3A, a GUI 400a includes a title, “NA Application Implementations,” an “insights” button 402, project metrics data 403, and a graph 404 that represents project metrics data in a graphical form. The GUI 400a may be generated by a project management application. The projects “LAF PPM,” “FOX Stores HCM,” and “FOX Stores Upgrade” may be projects that fall under the NA Application Implementations program managed by a software services company.

Based on a user selection of the button 402, the project management application changes the data presented in the GUI 400b. The GUI 400b presents a graph highlighting two projects, “FOX Stores Upgrade” and “Business World ERP,” that fall under the program “NA Application Implementations.” The GUI 400b displays an Insights panel 406. The insights panel includes an insight 407 that describes a key metric associated with the project “FOX Stores Upgrade.” The insights panel includes an insight 409 that describes a key metric associated with the project “Business World ERP.” The insights 407 and 409 are generated by a generative AI model. When the user selects the button 402, the project management application generates a prompt for the generative AI model with instructions to (a) identify a subset of the projects in the NA Application Implementations program based on performance metrics of the projects, (b) generate text content that includes at least one recommended action associated with a key metric for the subset of projects, and (c) include in the AI-generated response a description of a resource used to generate the recommended action.

The system generates software code that links text content in the insight 407 to a resource associated with a recommended action and identified by the generative AI model. In particular, the system generates software code to link the displayed words “Monitor project's cost performance” to a function of a project management application that generates alerts based on metrics values. The box 408 represents a hyperlink that directs the system to a webpage of the project management application that provides the alert-generation functionality.

The system generates software code that links text content “Address marginal financial discrepancies” in the insight 409 to a financial application that manages financial records and transactions. The box 410 represents a hyperlink to the financial application.

Based on a user selection of the hyperlink 410, the system presents GUI 400c. GUI 400c includes a program name 401, a selected insight 409, and content 412 generated by a financial application. The content 412 generated by the financial application includes a financial status summary 414. The financial status summary 414 includes warnings 416 and 418 that correspond to the recommended action “address marginal financial discrepancies” generated by the generative AI model. In the embodiment illustrated in FIGS. 4A-4C, the content generated by the generative AI model includes text content “Address marginal financial discrepancies to ensure a positive closeout” and non-text metadata identifying the financial application and the financial status summary that describes the marginal financial discrepancies (i.e., missing expense reports and cost exceeding budget). The system generates the hyperlink 410 using the non-text metadata. Selection of the hyperlink navigates the browser that generates the GUIs 400a-400c to the webpage content 412 provided by the financial application. The financial application provides further hyperlinks 420 and 422 to additional functions of the financial application to view expense reports and view a cost report for Team A.

### 6. Computer Networks and Cloud Networks

In one or more embodiments, a computer network provides connectivity among a set of nodes. The nodes may be local to and/or remote from each other. The nodes are connected by a set of links. Examples of links include a coaxial cable, an unshielded twisted cable, a copper cable, an optical fiber, and a virtual link.

A subset of nodes implements the computer network. Examples of such nodes include a switch, a router, a firewall, and a network address translator (NAT). Another subset of nodes uses the computer network. Such nodes (also referred to as “hosts”) may execute a client process and/or a server process. A client process makes a request for a computing service (such as, execution of a particular application, and/or storage of a particular amount of data). A server process responds by executing the requested service and/or returning corresponding data.

A computer network may be a physical network, including physical nodes connected by physical links. A physical node is any digital device. A physical node may be a function-specific hardware device, such as a hardware switch, a hardware router, a hardware firewall, and a hardware NAT. Additionally or alternatively, a physical node may be a generic machine that is configured to execute various virtual machines and/or applications performing respective functions. A physical link is a physical medium connecting two or more physical nodes. Examples of links include a coaxial cable, an unshielded twisted cable, a copper cable, and an optical fiber.

A computer network may be an overlay network. An overlay network is a logical network implemented on top of another network (such as, a physical network). Each node in an overlay network corresponds to a respective node in the underlying network. Hence, each node in an overlay network is associated with both an overlay address (to address to the overlay node) and an underlay address (to address the underlay node that implements the overlay node). An overlay node may be a digital device and/or a software process (such as, a virtual machine, an application instance, or a thread) A link that connects overlay nodes is implemented as a tunnel through the underlying network. The overlay nodes at either end of the tunnel treat the underlying multi-hop path between them as a single logical link. Tunneling is performed through encapsulation and decapsulation.

In an embodiment, a client may be local to and/or remote from a computer network. The client may access the computer network over other computer networks, such as a private network or the Internet. The client may communicate requests to the computer network using a communications protocol, such as Hypertext Transfer Protocol (HTTP). The requests are communicated through an interface, such as a client interface (such as a web browser), a program interface, or an application programming interface (API).

In an embodiment, a computer network provides connectivity between clients and network resources. Network resources include hardware and/or software configured to execute server processes. Examples of network resources include a processor, a data storage, a virtual machine, a container, and/or a software application. Network resources are shared amongst multiple clients. Clients request computing services from a computer network independently of each other. Network resources are dynamically assigned to the requests and/or clients on an on-demand basis.

### 7. Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs), field programmable gate arrays (FPGAs), or network processing units (NPUs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, FPGAs, or NPUs with custom programming to accomplish the techniques. The special-purpose computing devices may be desktop computer systems, portable computer systems, handheld devices, networking devices or any other device that incorporates hard-wired and/or program logic to implement the techniques.

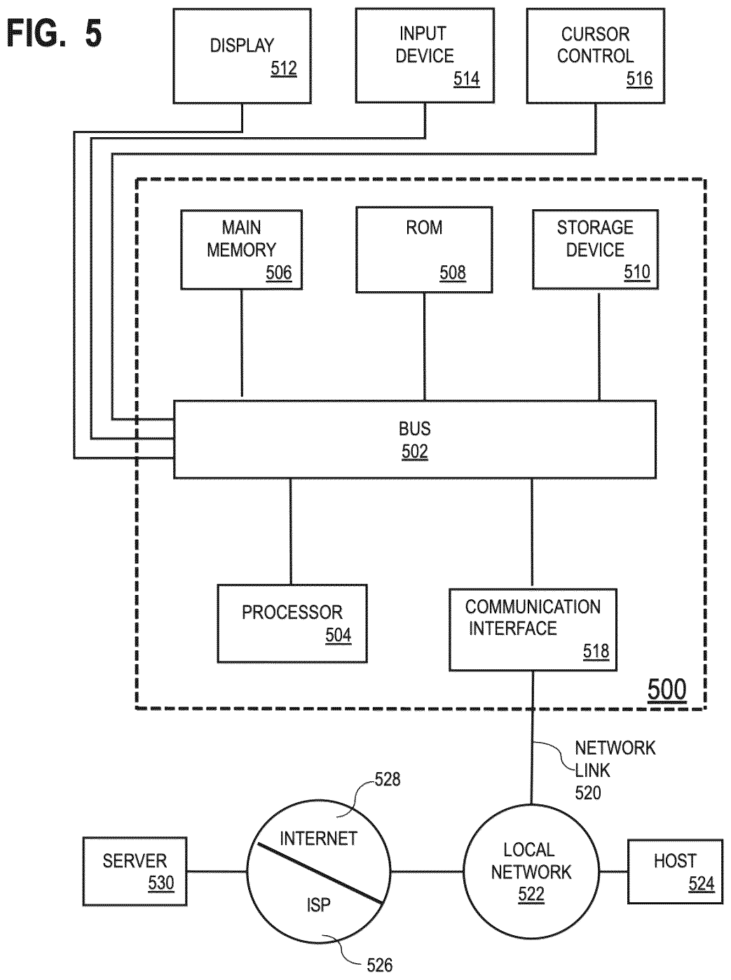

For example, FIG. 5 is a block diagram that illustrates a computer system 500 upon which an embodiment of the disclosure may be implemented. Computer system 500 includes a bus 502 or other communication mechanism for communicating information, and a hardware processor 504 coupled with bus 502 for processing information. Hardware processor 504 may be, for example, a general purpose microprocessor.

Computer system 500 also includes a main memory 506, such as a random access memory (RAM) or other dynamic storage device, coupled to bus 502 for storing information and instructions to be executed by processor 504. Main memory 506 also may be used for storing temporary variables or other intermediate information during execution of instructions to be executed by processor 504. Such instructions, when stored in non-transitory storage media accessible to processor 504, render computer system 500 into a special-purpose machine that is customized to perform the operations specified in the instructions.

Computer system 500 further includes a read only memory (ROM) 508 or other static storage device coupled to bus 502 for storing static information and instructions for processor 504. A storage device 510, such as a magnetic disk, optical disk, or a Solid State Drive (SSD) is provided and coupled to bus 502 for storing information and instructions.

Computer system 500 may be coupled via bus 502 to a display 512, such as a cathode ray tube (CRT), for displaying information to a computer user. An input device 514, including alphanumeric and other keys, is coupled to bus 502 for communicating information and command selections to processor 504. Another type of user input device is cursor control 516, such as a mouse, a trackball, or cursor direction keys for communicating direction information and command selections to processor 504 and for controlling cursor movement on display 512. This input device typically has two degrees of freedom in two axes, a first axis (e.g., x) and a second axis (e.g., y), that allows the device to specify positions in a plane.

Computer system 500 may implement the techniques described herein using customized hard-wired logic, one or more ASICs or FPGAs, firmware and/or program logic which in combination with the computer system causes or programs computer system 500 to be a special-purpose machine. According to one embodiment, the techniques herein are performed by computer system 500 in response to processor 504 executing one or more sequences of one or more instructions contained in main memory 506. Such instructions may be read into main memory 506 from another storage medium, such as storage device 510. Execution of the sequences of instructions contained in main memory 506 causes processor 504 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical or magnetic disks, such as storage device 510. Volatile media includes dynamic memory, such as main memory 506. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge, content-addressable memory (CAM), and ternary content-addressable memory (TCAM).

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor 504 retrieves and executes the instructions. The instructions received by main memory 506 may optionally be stored on storage device 510 either before or after execution by processor 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518.

The received code may be executed by processor 504 as it is received, and/or stored in storage device 510, or other non-volatile storage for later execution.

### 8. Miscellaneous; Extensions

Unless otherwise defined, all terms (including technical and scientific terms) are to be given their ordinary and customary meaning to a person of ordinary skill in the art, and are not to be limited to a special or customized meaning unless expressly so defined herein.

This application may include references to certain trademarks. Although the use of trademarks is permissible in patent applications, the proprietary nature of the marks should be respected and every effort made to prevent their use in any manner which might adversely affect their validity as trademarks.

Embodiments are directed to a system with one or more devices that include a hardware processor and that are configured to perform any of the operations described herein and/or recited in any of the claims below.

In an embodiment, one or more non-transitory computer readable storage media comprises instructions which, when executed by one or more hardware processors, cause performance of any of the operations described herein and/or recited in any of the claims.

In an embodiment, a method comprises operations described herein and/or recited in any of the claims, the method being executed by at least one device including a hardware processor.

Any combination of the features and functionalities described herein may be used in accordance with one or more embodiments. In the foregoing specification, embodiments have been described with reference to numerous specific details that may vary from implementation to implementation. The specification and drawings are, accordingly, to be regarded in an illustrative rather than a restrictive sense. The sole and exclusive indicator of the scope of the disclosure, and what is intended by the applicants to be the scope of the disclosure, is the literal and equivalent scope of the set of claims that issue from this application, in the specific form in which such claims issue, including any subsequent correction.

What is claimed is:

1. One or more non-transitory computer readable media comprising instructions which, when executed by one or more hardware processors, cause performance of operations comprising:
receiving a request directing a generative AI model to generate content including a recommendation based on a set of parameters;
based on the request, generating a first prompt including (a) instructions to generate the content including the recommendation based on the set of parameters and (b) an instruction directing the generative AI model to generate a response that specifies particular resources, among a set of resources, used to generate the recommendation;
inputting the first prompt to the generative AI model to obtain a response including (a) the recommendation, and (b) a description of a particular resource, among the set of resources, used to generate the recommendation;
determining a correlation between a function of the particular resource and an action specified in the recommendation; and
generating an augmented response to the request by adding a selectable user interface element in the response, wherein the selectable user interface element corresponds to the particular resource.

2. The one or more non-transitory computer readable media of claim 1, wherein generating the first prompt includes specifying, in the first prompt, the set of resources.

3. The one or more non-transitory computer readable media of claim 1, wherein the operations further comprise:
fine-tuning the generative AI model at least by appending a fine-tuning head to a trained model while freezing parameters of the trained model, wherein the fine-tuning head is trained on a dataset specifying system resources associated with recommended actions.

4. The one or more non-transitory computer readable media of claim 1, wherein selecting the selectable user interface element causes the particular resource to perform the function corresponding to the action specified in the recommendation.

5. The one or more non-transitory computer readable media of claim 1, wherein the set of resources includes a set of software tools.

6. The one or more non-transitory computer readable media of claim 1, wherein analyzing the generative AI model response includes applying a machine learning model to the generative AI model response to determine a portion of the generative AI model response corresponding to the action specified in the recommendation.

7. The one or more non-transitory computer readable media of claim 6, wherein applying the machine learning model to the response comprises:
generating a second prompt comprising:
text content of the response; and
an instruction to determine (a) the action and (b) the particular resource capable of performing the action by executing the function; and
inputting the second prompt to the generative AI model.

8. The one or more non-transitory computer readable media of claim 1, wherein the operations further comprise:
detecting a selection of the user interface element; and
responsive to detecting the selection: executing the function using the particular resource.

9. A method comprising:
receiving a request directing a generative AI model to generate content including a recommendation based on a set of parameters;
based on the request, generating a first prompt including (a) instructions to generate the content including the recommendation based on the set of parameters and (b) an instruction directing the generative AI model to generate a response that specifies particular resources, among a set of resources, used to generate the recommendation;
inputting the first prompt to the generative AI model to obtain a response including (a) the recommendation, and (b) a description of a particular resource, among the set of resources, used to generate the recommendation;
determining a correlation between a function of the particular resource and an action specified in the recommendation; and
generating an augmented response to the request by adding a selectable user interface element in the response, wherein the selectable user interface element corresponds to the particular resource,
wherein the method is performed by at least one device including a hardware processor.

10. The method of claim 9, wherein generating the first prompt includes specifying, in the first prompt, the set of resources.

11. The method of claim 9, further comprising:
fine-tuning the generative AI model at least by appending a fine-tuning head to a trained model while freezing parameters of the trained model, wherein the fine-tuning head is trained on a dataset specifying system resources associated with recommended actions.

12. The method of claim 9, wherein selecting the selectable user interface element causes the particular resource to perform the function corresponding to the action specified in the recommendation.

13. The method of claim 9, wherein the set of resources includes a set of software tools.

14. The method of claim 9, wherein analyzing the generative AI model response includes applying a machine learning model to the generative AI model response to determine a portion of the generative AI model response corresponding to the action specified in the recommendation.

15. The method of claim 14, wherein applying the machine learning model to the response comprises:
generating a second prompt comprising:
text content of the response; and
an instruction to determine (a) the action and (b) the particular resource capable of performing the action by executing the function; and
inputting the second prompt to the generative AI model.

16. The method of claim 9, further comprising:
detecting a selection of the user interface element; and
responsive to detecting the selection: executing the function using the particular resource.

17. A system comprising:
at least one device including a hardware processor;
the system being configured to perform operations comprising:
receiving a request directing a generative AI model to generate content including a recommendation based on a set of parameters;
based on the request, generating a first prompt including (a) instructions to generate the content including the recommendation based on the set of parameters and (b) an instruction directing the generative AI model to generate a response that specifies particular resources, among a set of resources, used to generate the recommendation;
inputting the first prompt to the generative AI model to obtain a response including (a) the recommendation, and (b) a description of a particular resource, among the set of resources, used to generate the recommendation;
determining a correlation between a function of the particular resource and an action specified in the recommendation; and
generating an augmented response to the request by adding a selectable user interface element in the response, wherein the selectable user interface element corresponds to the particular resource.

18. The system of claim 17, wherein generating the first prompt includes specifying, in the first prompt, the set of resources.

19. The system of claim 17, wherein the operations further comprise:
fine-tuning the generative AI model at least by appending a fine-tuning head to a trained model while freezing parameters of the trained model, wherein the fine-tuning head is trained on a dataset specifying system resources associated with recommended actions.

20. The system of claim 17, wherein selecting the selectable user interface element causes the particular resource to perform the function corresponding to the action specified in the recommendation.
